(19) United States
(12) Patent Application Publication
(10) Pub. No.: US 2025/0365086 A1
(43) Pub. Date: Nov. 27, 2025

(54) TIME SYNCHRONIZATION DEVICE, TIME SYNCHRONIZATION SYSTEM, AND TIME SYNCHRONIZATION METHOD

(71) Applicant: NIPPON TELEGRAPH AND TELEPHONE CORPORATION, Tokyo (JP)

(72) Inventors: Keisuke YAMAGATA, Tokyo (JP); Go YAZAWA, Tokyo (JP); Takashi NAKANISHI, Tokyo (JP)

(73) Assignee: NIPPON TELEGRAPH AND TELEPHONE CORPORATION, Tokyo (JP)

(21) Appl. No.: 18/872,038

(22) PCT Filed: Jun. 6, 2022
(86) PCT No.: PCT/JP2022/022831

§ 371 Date: Dec. 5, 2024

(51) Int. Cl. H04J 3/06

(52) U.S. Cl. CPC H04J 3/0667

(57) ABSTRACT

A time synchronization device (100) according to the present disclosure includes an offset assignment unit (106) as a synchronization unit that acquires an offset that is a difference between a first time of a time source (5) and a second time of the time synchronization device (100), and synchronizes a device internal time of a communication device (6) as a transmission destination of the first time of the time source (5) with the first time on the basis of the acquired offset and the second time.

### TECHNICAL FIELD

The present disclosure relates to a time synchronization device, a time synchronization system, and a time synchronization method.

### BACKGROUND ART

Precision Time Protocol (PTP) defined by the IEEE-1588 standard is a protocol for synchronizing times (device internal times) of computers on a local area network (LAN) with each other with high accuracy (see Non Patent Literature 1). FIG. 12 is a diagram illustrating a configuration example of a time synchronization system 10a that synchronizes times of devices on a network with each other by using a PTP protocol.

The time synchronization system 10a illustrated in FIG. 12 includes a Grand Master Clock 2, a Boundary Clock 3, and a client device 4. The Grand Master Clock 2 and the Boundary Clock 3 can communicate with each other via the network such as a LAN. In addition, the Boundary Clock 3 and the client device 4 can communicate with each other via the network such as a LAN.

The Grand Master Clock 2 includes a global navigation satellite system (GNSS) antenna that receives a signal (GNSS signal) from a satellite of a GNSS such as a global positioning system (GPS). The Grand Master Clock 2 receives the GNSS signal via the GNSS antenna, and acquires universal time coordinated (UTC) from the received GNSS signal. The Grand Master Clock 2 has a master function of distributing the acquired UTC as a reference time via the network.

The Boundary Clock 3 functions, for a higher-level device having the master function, as a device having a slave function of synchronizing a device internal time of the own device with a time distributed from the higher-level device, and functions, for a lower-level device having the slave function, as a device having the master function. In the time synchronization system 10a illustrated in FIG. 12, the Boundary Clock 3 functions as a device having the slave function for the Grand Master Clock 2, and functions as a device having the master function for the client device 4. Therefore, the Boundary Clock 3 measures an offset that is a difference between a device internal time of the Grand Master Clock 2, which is the higher-level device, and the device internal time of the own device by transmission and reception of a PTP packet with the Grand Master Clock 2, and synchronizes the device internal time of the own device with a time (reference time) distributed from the Grand Master Clock 2 on the basis of the measured offset. In addition, the Boundary Clock 3 distributes the device internal time to the client device 4 by transmission and reception of a PTP packet with the client device 4, and synchronizes a device internal time of the client device 4 with the device internal time of the own device.

The client device 4 has the slave function of synchronizing a device internal time with a time distributed from a device having the master function. In the time synchronization system 10a illustrated in FIG. 12, the client device 4 measures an offset that is a difference between a device internal time of the Boundary Clock 3, which is the higher-level device, and the device internal time of the own device by transmission and reception of a PTP packet with the Boundary Clock 3. Then, the client device 4 synchronizes the device internal time of the own device with the time distributed from the Boundary Clock 3 on the basis of the measured offset. The client device 4 is, for example, a base station device in a mobile phone network. Note that, in FIG. 12, the example in which the client device 4 synchronizes the device internal time of the own device with the time distributed from the Boundary Clock 3 by transmission and reception of the PTP packet with the Boundary Clock 3 has been described, but the present disclosure is not limited thereto. The client device 4 may synchronize the device internal time of the own device with a time distributed from the Grand Master Clock 2 by transmission and reception of a PTP packet with the Grand Master Clock 2

### CITATION LIST

### Non Patent Literature

Non Patent Literature 1: IEEE Std 1588TM-2008 “IEEE Standard for a Precision Clock Synchronization Protocol for Networked Measurement and Control Systems”

### SUMMARY OF INVENTION

### Technical Problem

In the time synchronization system 10a illustrated in FIG. 12, as described above, the client device 4 synchronizes the device internal time of the own device with the time (UTC) distributed from the Grand Master Clock 2 or the Boundary Clock 3. Here, as illustrated in FIG. 13, there is a case where there is a client device 4a that operates on a network (client network) operated at a unique time different from the UTC (for example, a case where a leap second is inserted at a timing different from that of the UTC). In this case, as illustrated in FIG. 13, the client device 4a needs to synchronize a device internal time of the own device with a time distributed from a Grand Master Clock 2a, which is a time source on the client network, instead of the Grand Master Clock 2 synchronized with the UTC.

As a method of synchronizing the device internal time of the client device 4a with the time distributed from the Grand Master Clock 2a, as described with reference to FIG. 12, a method in which the Grand Master Clock 2a and the client device 4a transmit and receive PTP packets can be considered. However, in this method, in a case where an area provided with the Grand Master Clock 2a and an area provided with the client device 4a are remote, it is necessary to construct a network between the Grand Master Clock 2a and the client device 4a, and an increase in cost becomes a problem.

As another method, a method in which a GNSS antenna is provided in the client device 4a, and special time information is individually transmitted to the client device 4a can also be considered. However, this method has problems such as a restriction due to installation of the GNSS antenna, an increase in cost due to installation of the GNSS antenna, and an increase in cost due to provision of the special time information.

As still another method, as illustrated in FIG. 13, a method in which a device internal time of the Boundary Clock 3 on a network different from the client network is synchronized with the time of the Grand Master Clock 2a, and the time distributed from the Grand Master Clock 2a is transmitted to the client device 4a via the Boundary Clock 3 can be considered. However, the Boundary Clock 3 can usually be synchronized only with a time distributed from one time source. Therefore, it is difficult to transmit the time distributed from the Grand Master Clock 2a to the client device 4a via the Boundary Clock 3.

Therefore, as still another method, a method in which the inside of the Boundary Clock 3 is logically divided, and each logical block is provided with a device internal time so as to be synchronized with a plurality of times can be considered. FIG. 14 illustrates a configuration example of the Boundary Clock 3 to which such a method is applied and which can be synchronized with a plurality of times.

As illustrated in FIG. 14, the Boundary Clock 3 that can be synchronized with a plurality of times includes packet transmission/reception units 31, 34, and 38, offset calculation units 32 and 35, time synchronization processing units 33 and 36, and a time switching unit 37.

The packet transmission/reception unit 31 generates a PTP packet on the basis of a device internal time (first device internal time) of the Boundary Clock 3, and performs transmission and reception of the PTP packet with the Grand Master Clock 2. The packet transmission/reception unit 31 outputs the packet received from the Grand Master Clock 2 to the offset calculation unit 32.

The offset calculation unit 32 calculates an offset that is a difference between the device internal times (first device internal times) of the Grand Master Clock 2 and the Boundary Clock 3. Specifically, the offset calculation unit 32 acquires a time stamp from the packet output from the packet transmission/reception unit 31, and calculates the offset on the basis of the acquired time stamp. The offset calculation unit 32 outputs a result of the calculation of the offset to the time synchronization processing unit 33.

The time synchronization processing unit 33 synchronizes the device internal time (first device internal time) of the Boundary Clock 3 with the device internal time of the Grand Master Clock 2 on the basis of the offset calculated by the offset calculation unit 32.

The packet transmission/reception unit 34 generates a PTP packet on the basis of a device internal time (second device internal time) of the Boundary Clock 3, and performs transmission and reception of the PTP packet with the Grand Master Clock 2a. The packet transmission/reception unit 34 outputs the packet received from the Grand Master Clock 2a to the offset calculation unit 35.

The offset calculation unit 35 calculates an offset that is a difference between the device internal times (second device internal times) of the Grand Master Clock 2a and the Boundary Clock 3. Specifically, the offset calculation unit 35 acquires a time stamp from the packet output from the packet transmission/reception unit 34, and calculates the offset on the basis of the acquired time stamp. The offset calculation unit 35 outputs a result of the calculation of the offset to the time synchronization processing unit 36.

The time synchronization processing unit 36 synchronizes the device internal time (second device internal time) of the Boundary Clock 3 with the device internal time of the Grand Master Clock 2a on the basis of the offset calculated by the offset calculation unit 35.

The time switching unit 37 switches between the first device internal time and the second device internal time according to the client devices 4 and 4a with which the Boundary Clock 3 synchronizes the time, and outputs the first device internal time or the second device internal time to the packet transmission/reception unit 38.

The packet transmission/reception unit 38 performs transmission and reception of a PTP packet with the client devices 4 and 4a. The packet subjected to the transmission and reception with the client devices 4 and 4a includes time information regarding the device internal time (the first device internal time or the second device internal time) of the Boundary Clock 3. By the transmission and reception of the packet including the time information, the device internal times of the client devices 4 and 4a can be synchronized with the device internal time (the first device internal time or the second device internal time) of the Boundary Clock 3.

According to the Boundary Clock 3 illustrated in FIG. 14, the Boundary Clock 3 can be synchronized with the device internal times of the plurality of Grand Master Clocks 2 and 2a, and can synchronize the device internal time of each of the client devices 4 and 4a with a desired time. However, according to the Boundary Clock 3 illustrated in FIG. 14, since a configuration for the synchronization with the device internal time of each of the plurality of Grand Master Clocks 2 and 2a is required, the configuration of the Boundary Clock 3 becomes complicated, which leads to an increase in cost.

An object of the present disclosure made in view of the above problems is to provide a time synchronization device, a time synchronization system, and a time synchronization method capable of synchronizing a device internal time of a communication device with a time of a time source different from a device internal time of the own device while suppressing an increase in cost.

### Solution to Problem

In order to solve the above problem, a time synchronization device according to the present disclosure is a time synchronization device that is capable of communicating with a first time source and a communication device as a transmission destination of a first time of the first time source, and that has a second time serving as a reference in the device, and the time synchronization device includes a synchronization unit that acquires an offset that is a difference between the first time and the second time, and synchronizes a device internal time of the communication device with the first time on the basis of the acquired offset and the second time.

In order to solve the above problem, a time synchronization system according to the present disclosure includes: a time source that outputs a first time; a communication device as a transmission destination of the first time of the time source; and a time synchronization device that is capable of communicating with the time source and the communication device, and that has a second time in the device, in which the time synchronization device acquires an offset that is a difference between the first time and the second time, and synchronizes a device internal time of the communication device with the first time on the basis of the acquired offset and the second time.

In addition, in order to solve the above problem, a time synchronization method according to the present disclosure is a time synchronization method by a time synchronization device that is capable of communicating with a first time source and a communication device as a transmission destination of a first time of the first time source, and that has a second time serving as a reference in the device, and the time synchronization method includes: a step of acquiring an offset that is a difference between the first time and the second time; and a step of synchronizing a device internal time of the communication device with the first time on the basis of the acquired offset and the second time.

### Advantageous Effects of Invention

According to a time synchronization device, a time synchronization system, and a time synchronization method according to the present disclosure, it is possible to synchronize a device internal time of a communication device with a time of a time source different from a device internal time of the own device while suppressing an increase in cost.

### BRIEF DESCRIPTION OF DRAWINGS

FIG. 1 is a diagram illustrating a configuration example of a time synchronization system to which a time synchronization device according to a first embodiment of the present disclosure is applied.

FIG. 2 is a flowchart illustrating an example of operation of the time synchronization device illustrated in FIG. 1.

FIG. 3 is a diagram for describing synchronization of a device internal time of a communication device with a time of a time source in the time synchronization system illustrated in FIG. 1.

FIG. 4A is a diagram for describing transmission and reception of a PTP packet between the time synchronization device and a Grand Master Clock illustrated in FIG. 3.

FIG. 4B is a diagram for describing transmission and reception of a PTP packet between the time synchronization device and the time source illustrated in FIG. 3.

FIG. 4C is a diagram for describing transmission and reception of a PTP packet between the time synchronization device and the communication device illustrated in FIG. 3.

FIG. 5 is a diagram illustrating a configuration example of a time synchronization system to which a time synchronization device according to a second embodiment of the present disclosure is applied.

FIG. 6 is a diagram for describing transmission and reception of a PTP packet between the time synchronization device and a communication device illustrated in FIG. 5.

FIG. 7 is a diagram illustrating a configuration example of a time synchronization system to which a time synchronization device according to a third embodiment of the present disclosure is applied.

FIG. 8 is a diagram illustrating another configuration example of the time synchronization system to which the time synchronization device according to the third embodiment of the present disclosure is applied.

FIG. 9 is a diagram illustrating a configuration example of a time synchronization system to which a time synchronization device according to a fourth embodiment of the present disclosure is applied.

FIG. 10 is a diagram illustrating a configuration example of a time synchronization system to which a time synchronization device according to a fifth embodiment of the present disclosure is applied.

FIG. 11 is a diagram illustrating an example of a hardware configuration of the time synchronization devices according to the present disclosure.

FIG. 12 is a diagram illustrating a configuration example of a conventional time synchronization system.

FIG. 13 is a diagram for describing problems of the time synchronization system illustrated in FIG. 12.

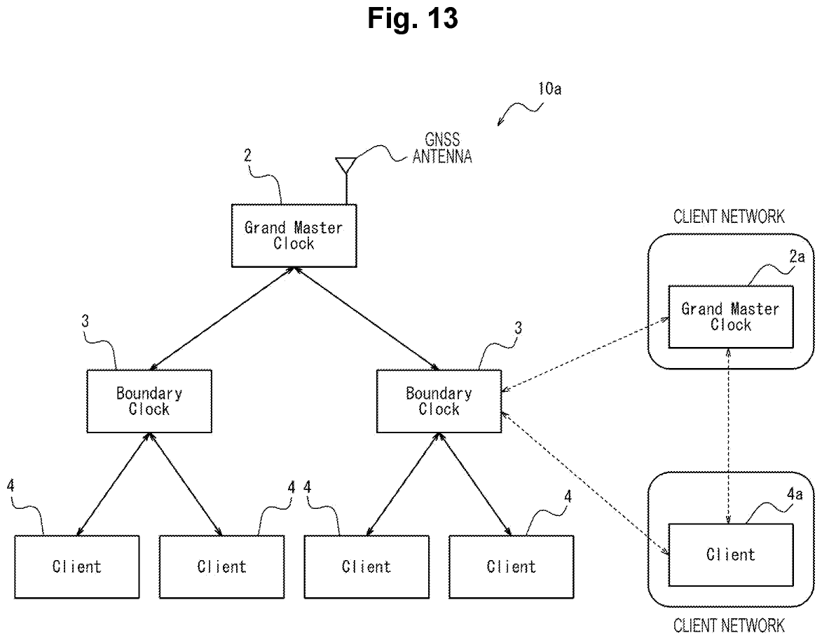

FIG. 14 is a diagram illustrating a configuration example of a Boundary Clock illustrated in FIG. 13.

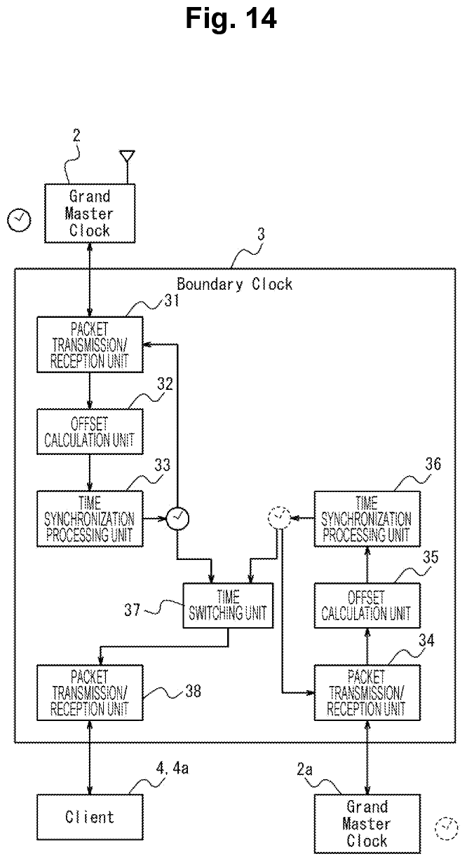

### DESCRIPTION OF EMBODIMENTS

Hereinafter, embodiments of the present disclosure will be described with reference to the drawings.

### First Embodiment

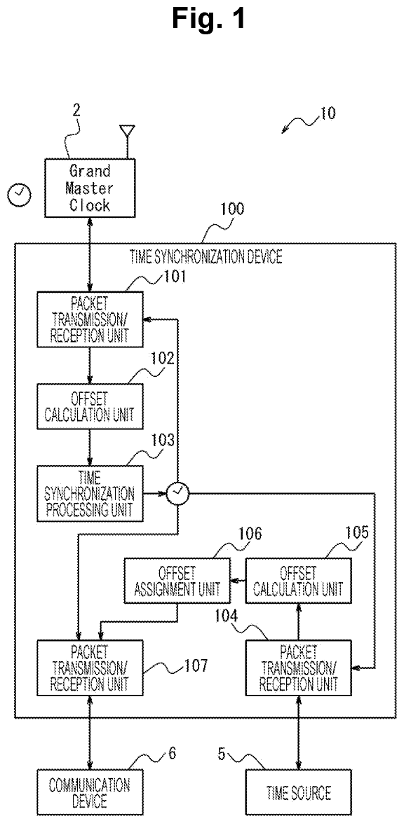

FIG. 1 is a diagram illustrating a configuration example of a time synchronization system 10 to which a time synchronization device 100 according to a first embodiment of the present disclosure is applied.

As illustrated in FIG. 1, the time synchronization system 10 includes a Grand Master Clock 2, a time source 5, a communication device 6, and the time synchronization device 100. The Grand Master Clock 2 and the time synchronization device 100, the time source 5 and the time synchronization device 100, and the communication device 6 and the time synchronization device 100 can communicate with each other via, for example, a network such as a LAN provided by a communication carrier. In addition, it is assumed that the time source 5 and the communication device 6 cannot directly communicate with each other.

The Grand Master Clock 2 receives a GNSS signal via a GNSS antenna, and acquires UTC from the received GNSS signal. The Grand Master Clock 2 distributes the acquired UTC to the time synchronization device 100 via the network.

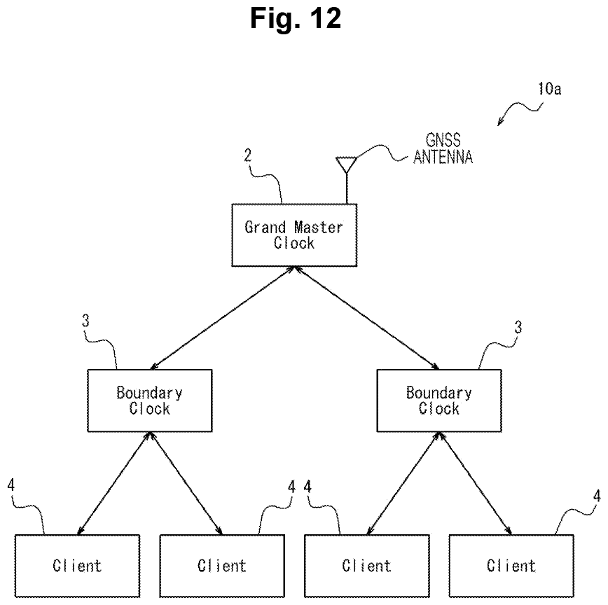

The time source 5 distributes a time different from that of the Grand Master Clock 2. The time source 5 is, for example, the Grand Master Clock 2a illustrated in FIG. 12.

The communication device 6 is a device operated according to a time distributed from the time source 5. Therefore, the communication device 6 needs to synchronize a device internal time with the time distributed from the time source 5. The communication device 6 is, for example, the client device 4a illustrated in FIG. 12. A client that operates the communication device 6 notifies a carrier of, for example, information regarding a time operated in the communication device 6 (for example, a date and time when a leap second is inserted, and the like). The carrier operates the time source 5 in response to the notification from the client.

The time synchronization device 100 according to the present embodiment can communicate with the time source 5 as a first time source and the communication device 6 as a transmission destination of a time of the time source 5 (first time). In addition, the time synchronization device 100 according to the present embodiment has a device internal time (second time) serving as a reference in the device. In addition, the time synchronization device 100 according to the present embodiment can communicate with the Grand Master Clock 2 as a second time source having a third time (for example, UTC) as a device internal time. The time synchronization device 100 acquires an offset that is a difference between the time of the time source 5 and the device internal time of the time synchronization device 100. Then, the time synchronization device 100 synchronizes the device internal time of the communication device 6 with the time of the time source 5 on the basis of the acquired offset and the device internal time of the time synchronization device 100.

As described above, the time synchronization system 10 according to the present embodiment includes the time source 5 that outputs the first time, the communication device 6 as the transmission destination of the first time of the time source 5, and the time synchronization device 100 that can communicate with the time source 5 and the communication device 6 and has the second time in the device. The time synchronization device 100 acquires the offset that is the difference between the first time and the second time, and synchronizes the device internal time of the communication device 6 with the first time on the basis of the acquired offset and the second time.

Next, a configuration of the time synchronization device 100 according to the present embodiment will be described with reference to FIG. 1.

As illustrated in FIG. 1, the time synchronization device 100 according to the present embodiment includes packet transmission/reception units 101, 104, and 107, offset calculation units 102 and 105, a time synchronization processing unit 103, and an offset assignment unit 106. The offset assignment unit 106 is an example of a synchronization unit.

The packet transmission/reception unit 101 generates a PTP packet on the basis of the device internal time of the time synchronization device 100, and performs transmission and reception of the PTP packet with the Grand Master Clock 2. The packet transmission/reception unit 101 outputs the packet received from the Grand Master Clock 2 to the offset calculation unit 102.

The offset calculation unit 102 calculates an offset that is a difference between device internal times of the Grand Master Clock 2 and the time synchronization device 100. Specifically, the offset calculation unit 102 acquires a time stamp from the packet output from the packet transmission/reception unit 101, and calculates the offset on the basis of the acquired time stamp. The offset calculation unit 102 outputs a result of the calculation of the offset to the time synchronization processing unit 103.

The time synchronization processing unit 103 synchronizes the device internal time of the time synchronization device 100 with the device internal time of the Grand Master Clock 2 on the basis of the offset calculated by the offset calculation unit 102. As described above, the time synchronization device 100 has the device internal time (second time) serving as the reference in the device. Then, the time synchronization device 100 synchronizes the device internal time (second time) with the time distributed from the Grand Master Clock 2. As described above, the device internal time of the Grand Master Clock 2 is synchronized with the UTC. Therefore, the reference time (device internal time) of the time synchronization device 100 can be stabilized by synchronizing the device internal time of the time synchronization device 100 with the device internal time of the Grand Master Clock 2 (that is, by synchronizing with the UTC (third time)).

The packet transmission/reception unit 104 generates a PTP packet on the basis of the device internal time of the time synchronization device 100, and performs transmission and reception of the PTP packet with the time source 5. The packet transmission/reception unit 104 outputs the packet received from the time source 5 to the offset calculation unit 105.

The offset calculation unit 105 calculates an offset that is a difference between the device internal time of the time source 5 and the device internal time of the time synchronization device 100. Specifically, the offset calculation unit 105 acquires a time stamp from the packet output from the packet transmission/reception unit 104, and calculates the offset on the basis of the acquired time stamp. The offset calculation unit 105 outputs a result of the calculation of the offset to the offset assignment unit 106.

The offset assignment unit 106 generates offset information indicating the offset (the difference between the device internal time of the time source 5 and the device internal time of the time synchronization device 100) output from the offset calculation unit 105, and outputs the offset information to the packet transmission/reception unit 107.

The packet transmission/reception unit 107 generates a PTP packet on the basis of the device internal time of the time synchronization device 100, and performs transmission and reception of the PTP packet with the communication device 6. Here, the packet transmission/reception unit 107 notifies the communication device 6 of the offset indicated in the offset information output from the offset assignment unit 106 together with the device internal time of the time synchronization device 100 by exchanging the PTP packet with the communication device 6. In PTP, a value called collection field is defined as information for correcting a processing delay or the like in a device. For example, the packet transmission/reception unit 107 inserts a value obtained by adding a value of the offset indicated in the offset information to the value of the collection field of the PTP packet exchanged with the communication device 6. As a result, it is possible to notify the communication device 6 of the offset that is the difference between the device internal time of the time source 5 and the device internal time of the time synchronization device 100. Although details will be described later, the communication device 6 synchronizes the device internal time of the communication device 6 with the time (second time) of the time source 5 on the basis of the device internal time of the time synchronization device 100 and the offset that is the difference between the device internal time of the time source 5 and the device internal time of the time synchronization device 100, which are notified from the packet transmission/reception unit 107.

As described above, the time synchronization device 100 according to the present embodiment includes the offset assignment unit 106 as the synchronization unit. The offset assignment unit 106 acquires, from the offset calculation unit 105, the offset that is the difference between the device internal time of the time synchronization device 100 and the device internal time of the time source 5. Then, the offset assignment unit 106 notifies the communication device 6 of the device internal time of the time synchronization device 100 and the acquired offset via the packet transmission/reception unit 107. As a result, the offset assignment unit 106 synchronizes the device internal time of the communication device 6 with the time of the time source 5 on the basis of the acquired offset and the device internal time of the time synchronization device 100.

Therefore, the device internal time of the communication device 6 can be synchronized with the time of the time source 5 without configuring a network connecting the time source 5 and the communication device 6. In addition, since the time synchronization device 100 does not need to synchronize the device internal time with a plurality of times, it is possible to prevent the configuration of the time synchronization device 100 from becoming complicated. Therefore, according to the time synchronization device 100 according to the present embodiment, it is possible to synchronize the device internal time of the communication device 6 with the time of the time source 5 different from the device internal time of the own device while suppressing an increase in cost.

Next, operation of the time synchronization device 100 according to the present embodiment will be described.

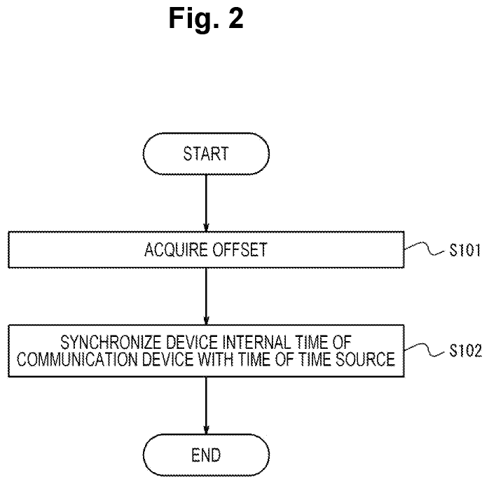

FIG. 2 is a flowchart illustrating an example of the operation of the time synchronization device 100 according to the present embodiment, and is a diagram for describing a time synchronization method by the time synchronization device 100 according to the present embodiment.

The offset assignment unit 106 acquires an offset that is a difference between a device internal time of the time synchronization device 100 and a device internal time of the time source 5 (step S101). In the present embodiment, the offset calculation unit 105 calculates the offset on the basis of a time stamp included in a PTP packet transmitted and received between the time synchronization device 100 and the time source 5. The offset assignment unit 106 acquires the offset from the offset calculation unit 105.

Next, the offset assignment unit 106 synchronizes a device internal time of the communication device 6 with the time (first time) of the time source 5 on the basis of the acquired offset and the device internal time (second time) in the time synchronization device 100 (step S102). Specifically, the offset assignment unit 106 notifies the communication device 6 of the offset and the device internal time in the time synchronization device 100 via a PTP packet transmitted from the packet transmission/reception unit 107 to the communication device 6. The communication device 6 synchronizes the device internal time of the communication device 6 with the time of the time source 5 on the basis of the offset notified from the time synchronization device 100 and the device internal time of the time synchronization device 100.

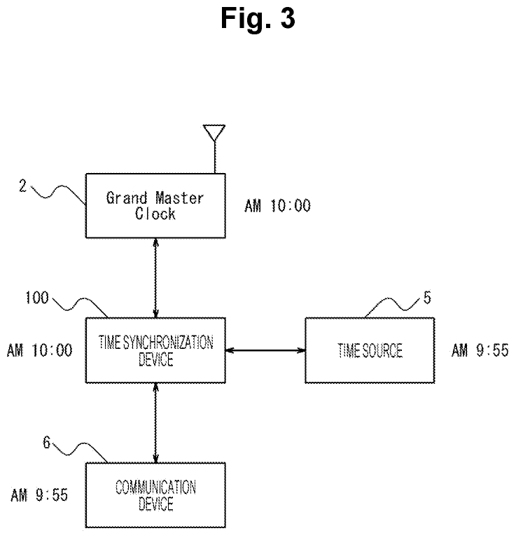

Next, the synchronization of the device internal time of the communication device 6 with the time of the time source 5 in the time synchronization system 10 according to the present embodiment will be described. Hereinafter, description will be given using an example in which, as illustrated in FIG. 3, the time of the time source 5 is operated 5 minutes earlier than the device internal times (AM 10:00) of the Grand Master Clock 2 and the time synchronization device 100, and the device internal time of the communication device 6 is synchronized with the time of the time source 5 (AM 9:55).

Note that, as a method of time synchronization by the PTP, there are an end-to-end (E2E) method and a peer-to-peer (P2P) method. Hereinafter, the E2E method will be described as an example, but calculation of an offset based on a time stamp included in a PTP packet, which will be described later, is basically the same in the P2P method.

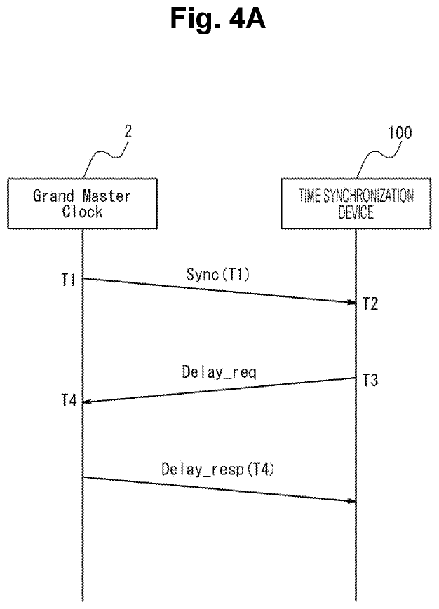

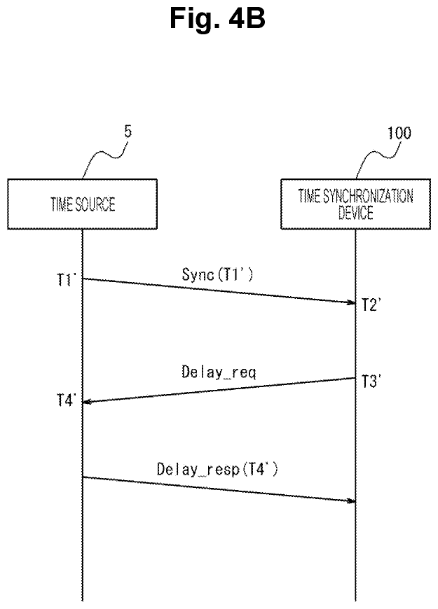

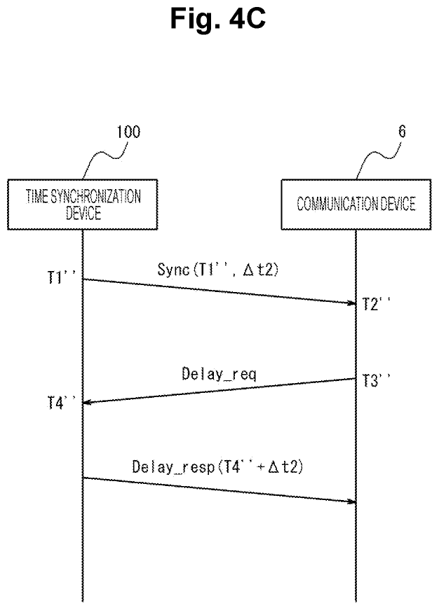

The time synchronization device 100 synchronizes the device internal time of the own device with the device internal time of the Grand Master Clock 2 by transmission and reception of a PTP packet with the Grand Master Clock 2 FIG. 4A is a diagram illustrating an example of transmission and reception of a PTP packet (message) between the time synchronization device 100 and the Grand Master Clock 2.

As illustrated in FIG. 4A, the Grand Master Clock 2 transmits a Sync message (synchronization message) to the time synchronization device 100 at a time T1. The Grand Master Clock 2 includes, in the Sync message, a time stamp indicating the time T1 that is a transmission time of the Sync message.

When receiving the Sync message transmitted from the Grand Master Clock 2 at a time T2, the time synchronization device 100 (packet transmission/reception unit 101) transmits a Delay_Req message (delay request message) to the Grand Master Clock 2 at a time T3.

When receiving the Delay_Req message transmitted from the time synchronization device 100 at a time T4, the Grand Master Clock 2 transmits a Delay_Resp message (delay response message) to the time synchronization device 100. The Grand Master Clock 2 includes, in the Delay_Resp message, a time stamp indicating the time T4 that is a reception time of the Delay_Req message.

Assuming that a difference between the device internal time of the Grand Master Clock 2 and the device internal time of the time synchronization device 100 (offset) is Δt1, the offset calculation unit 102 calculates Δt1 on the basis of the following expression.

$$Δ t 1 = ( ( T 2 - T 1 ) - ( T 4 - T 3 ) ) / 2$$

As described above, the Sync message includes the time stamp indicating the time T1, and the Delay_Resp message includes the time stamp indicated by the time T4. Therefore, the offset calculation unit 102 can grasp the time T1 and the time T4 from these messages. In addition, the time T2 and the time T3 are known in the time synchronization device 100. Therefore, the offset calculation unit 102 can calculate the offset Δt1 by the expression described above. The time synchronization processing unit 103 adjusts the device internal time of the time synchronization device 100 by the calculated offset Δt1. As a result, the device internal time of the time synchronization device 100 can be synchronized with the device internal time of the Grand Master Clock 2.

Referring back to FIG. 3, the time synchronization device 100 calculates an offset that is a difference between the time of the time source 5 and the device internal time of the time synchronization device 100 by transmission and reception of a PTP packet with the time source 5. FIG. 4B is a diagram illustrating an example of transmission and reception of a PTP packet (message) between the time synchronization device 100 and the time source 5.

As illustrated in FIG. 4B, the time source 5 transmits a Sync message to the time synchronization device 100 at a time T1′. The time source 5 includes, in the Sync message, a time stamp indicating the time T1′ that is a transmission time of the Sync message.

When receiving the Sync message transmitted from the time source 5 at a time T2′, the time synchronization device 100 (packet transmission/reception unit 104) transmits a Delay_Req message to the time source 5 at a time T3′.

When receiving the Delay_Req message transmitted from the time synchronization device 100 at a time T4′, the time source 5 transmits a Delay_Resp message to the time synchronization device 100. The time source 5 includes, in the Delay_Resp message, a time stamp indicating the time T1′ that is a reception time of the Delay_Req message.

Assuming that a difference between the device internal time of the time source 5 and the device internal time of the time synchronization device 100 (offset) is Δt2, the offset calculation unit 105 calculates Δt2 on the basis of the following expression.

$$Δ t 2 = ( ( T {2}^{′} - T {1}^{′} ) - ( T {4}^{′} - T {3}^{′} ) ) / 2$$

As described above, the Sync message includes the time stamp indicating the time T1′, and the Delay_Resp message includes the time stamp indicated by the time T4′. Therefore, the offset calculation unit 105 can grasp the time T1′ and the time T4′ from these messages. In addition, the time T2′ and the time T3′ are known in the time synchronization device 100. Therefore, the offset calculation unit 105 can calculate the offset Δt2 by the expression described above. In the present embodiment, the time synchronization device 100 does not synchronize the device internal time of the own device with the time of the time source 5. Therefore, in the example illustrated in FIG. 3, the offset Δt2 is always a value of about 5 minutes.

Referring back to FIG. 3, the time synchronization device 100 notifies the communication device 6 of the device internal time of the time synchronization device 100 and the offset Δt2 by transmission and reception of a PTP packet with the communication device 6. FIG. 4C is a diagram illustrating an example of transmission and reception of a PTP packet (message) between the time synchronization device 100 and the communication device 6.

As illustrated in FIG. 4C, the time synchronization device 100 (offset assignment unit 106) transmits a Sync message to the communication device 6 at a time T1″ via the packet transmission/reception unit 107. The packet transmission/reception unit 107 includes, in the Sync message, a time stamp indicating the time T1″ that is a transmission time of the Sync message. In addition, the packet transmission/reception unit 107 includes, in the Sync message, the offset Δt2 calculated by the offset calculation unit 105. For example, the packet transmission/reception unit 107 inserts a value of the offset Δt2 into a correction field of the Sync message.

When receiving the Sync message transmitted from the time synchronization device 100 at a time T2″, the communication device 6 transmits a Delay_Req message to the time synchronization device 100 at a time T3″.

When receiving the Delay_Req message transmitted from the communication device 6 at a time T4″, the time synchronization device 100 transmits a Delay_Resp message to the communication device 6. The time synchronization device 100 includes, in the Delay_Resp message, a time stamp indicating a time (T4″+Δt2) obtained by shifting the time T4″ that is a reception time of the Delay_Req message by the offset Δt2.

The communication device 6 calculates an offset Δt3 that is a difference between the time shifted by the offset Δt2 from the device internal time of the time synchronization device 100 and the device internal time of the communication device 6 on the basis of the following expression.

$$Δ t 3 = T {2}^{″} - T {1}^{″} - ( ( ( T {4}^{″} + Δ t 2 ) - ( T {1}^{″} - Δ t 2 ) ) - ( T {3}^{″} - T {2}^{″} ) ) / 2 = T {2}^{″} - T {1}^{″} - ( ( T {4}^{″} - T {1}^{″} ) - ( T {31}^{″} - T {2}^{″} ) ) / 2 - Δ t 2$$

The communication device 6 adjusts the device internal time of the communication device 6 by the calculated offset Δt3. As a result, the device internal time of the communication device 6 can be synchronized with the time of the time source 5.

As described above, the time synchronization device 100 according to the present embodiment includes the offset assignment unit 106 as the synchronization unit. The offset assignment unit 106 acquires, from the offset calculation unit 105, the offset that is the difference between the device internal time (first time) of the time synchronization device 100 and the time (second time) of the time source 5. Then, the offset assignment unit 106 synchronizes the device internal time of the communication device 6 with the time of the time source 5 on the basis of the acquired offset and the device internal time of the time synchronization device 100. Specifically, the offset assignment unit 106 notifies, via the packet transmission/reception unit 107, the communication device 6 of the device internal time of the time synchronization device 100 and the acquired offset, and synchronizes the device internal time of the communication device 6 with the time of the time source 5.

Since the device internal time of the communication device 6 can be synchronized with the time of the time source 5 without communication between the time source 5 and the communication device 6, a network connecting the time source 5 and the communication device 6 is unnecessary, and thus an increase in cost can be suppressed. In addition, since it is not necessary to synchronize the device internal time of the time synchronization device 100 with a plurality of times, it is possible to prevent the configuration of the time synchronization device 100 from becoming complicated. Therefore, according to the time synchronization device 100 according to the present embodiment, it is possible to synchronize the device internal time of the communication device 6 with the time of the time source 5 different from the device internal time of the own device while suppressing an increase in cost.

### Second Embodiment

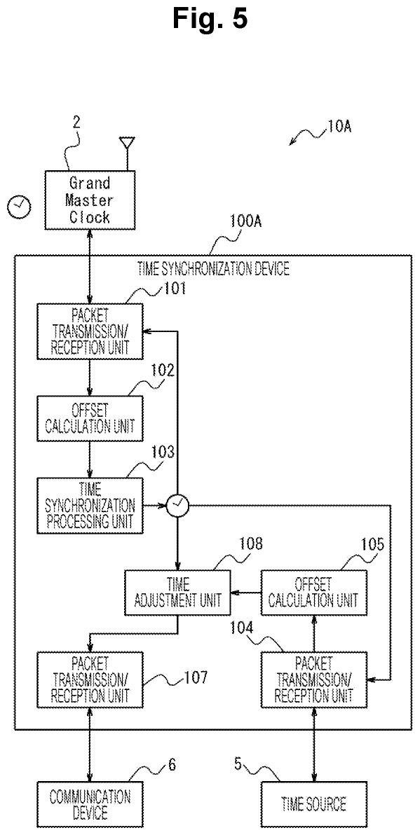

FIG. 5 is a diagram illustrating a configuration example of a time synchronization system 10A to which a time synchronization device 100A according to a second embodiment of the present disclosure is applied. In FIG. 5, configurations similar to those in FIG. 1 are denoted by the same reference signs, and description thereof will be omitted.

As illustrated in FIG. 5, the time synchronization system 10A includes a Grand Master Clock 2, a time source 5, a communication device 6, and the time synchronization device 100A. The time synchronization system 10A illustrated in FIG. 5 is different from the time synchronization system 10 illustrated in FIG. 1 in that the time synchronization device 100 is changed to the time synchronization device 100A.

As illustrated in FIG. 5, the time synchronization device 100A according to the present embodiment includes packet transmission/reception units 101, 104, and 107, offset calculation units 102 and 105, and a time adjustment unit 108. The time synchronization device 100A according to the present embodiment is different from the time synchronization device 100 according to the first embodiment in that the offset assignment unit 106 is deleted and the time adjustment unit 108 is added.

The time adjustment unit 108 acquires an offset (a difference between a device internal time of the time source 5 and a device internal time of the time synchronization device 100A) calculated by the offset calculation unit 105. The time adjustment unit 108 outputs a time obtained by correcting the device internal time of the time synchronization device 100A on the basis of the offset to the packet transmission/reception unit 107.

The packet transmission/reception unit 107 notifies the communication device 6 of the time output from the time adjustment unit 108 by exchanging a PTP packet with the communication device 6. Although details will be described later, the communication device 6 synchronizes a device internal time of the own device with the time notified from the packet transmission/reception unit 107 (time obtained by correcting the device internal time of the time synchronization device 100A on the basis of the acquired offset).

As described above, in the time synchronization device 100A according to the present embodiment, the time adjustment unit 108 as the synchronization unit acquires, from the offset calculation unit 105, the offset that is the difference between the device internal time of the time synchronization device 100A and the device internal time of the time source 5. Then, the time adjustment unit 108 notifies, via the packet transmission/reception unit 107, the communication device 6 of the time obtained by correcting the device internal time of the time synchronization device 100A on the basis of the acquired offset. As a result, the time adjustment unit 108 synchronizes the device internal time of the communication device 6 with the time of the time source 5 on the basis of the acquired offset and the device internal time of the time synchronization device 100.

Therefore, the device internal time of the communication device 6 can be synchronized with the time of the time source 5 without configuring a network connecting the time source 5 and the communication device 6. In addition, since the time synchronization device 100A does not need to synchronize the device internal time with a plurality of times, it is possible to prevent the configuration of the time synchronization device 100A from becoming complicated. Therefore, according to the time synchronization device 100A according to the present embodiment, it is possible to synchronize the device internal time of the communication device 6 with the time of the time source 5 different from the device internal time of the own device while suppressing an increase in cost.

Next, the synchronization of the device internal time of the communication device 6 with the time of the time source 5 in the time synchronization system 10A according to the present embodiment will be described with reference to an example illustrated in FIG. 3.

Transmission and reception of a PTP packet between the time synchronization device 100A and the Grand Master Clock 2 for synchronizing the device internal time of the time synchronization device 100A with a device internal time of the Grand Master Clock 2 are similar to those in FIG. 4A, and thus, description thereof is omitted. In addition, transmission and reception of a PTP packet between the time synchronization device 100A and the time source 5 for calculating an offset between the device internal time of the time synchronization device 100A and the time of the time source 5 are similar to those in FIG. 4B, and thus, description thereof is omitted.

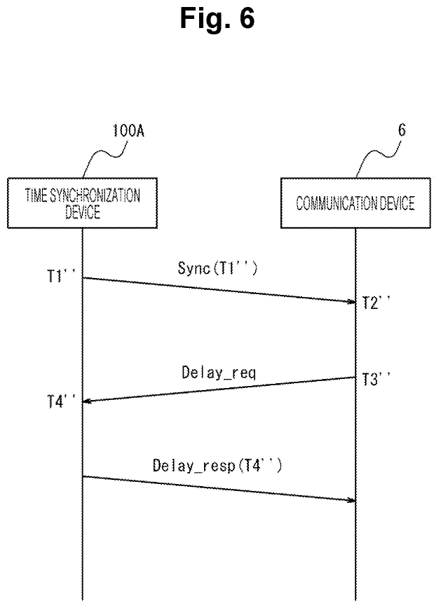

FIG. 6 is a diagram illustrating an example of transmission and reception of a PTP packet between the time synchronization device 100A and the communication device 6 according to the present embodiment.

As illustrated in FIG. 6, the time synchronization device 100A (time adjustment unit 108) transmits a Sync message to the communication device 6 at a time T1″ via the packet transmission/reception unit 107. Here, as the time T1″ that is a transmission time of the Sync message, the time adjustment unit 108 outputs, to the packet transmission/reception unit 107, a time obtained by shifting the actual transmission time of the Sync message by an acquired offset Δt2. The packet transmission/reception unit 107 includes, in the Sync message, a time stamp indicating the time after the correction by the time adjustment unit 108 as a time stamp of the time T1″ that is the transmission time of the Sync message.

When receiving the Sync message transmitted from the time synchronization device 100A at a time T2″, the communication device 6 transmits a Delay_Req message to the time synchronization device 100A at a time T3″.

When receiving the Delay_Req message transmitted from the communication device 6 at a time T4″, the time synchronization device 100A transmits a Delay_Resp message to the communication device 6. Here, as the time T4″ that is a reception time of the Delay_Req message, the time adjustment unit 108 outputs, to the packet transmission/reception unit 107, a time obtained by shifting the actual reception time of the Delay_Req message by the acquired offset Δt2. The packet transmission/reception unit 107 includes, in the Delay_Resp message, a time stamp indicating the time after the correction by the time adjustment unit 108 as a time stamp of the time T4″ that is a reception time of the Delay_Req message.

The communication device 6 calculates an offset Δt3 that is a difference between the time shifted by the offset Δt2 from the device internal time of the time synchronization device 100A and the device internal time of the communication device 6 on the basis of the following expression. Note that t1 is the device internal time of the time synchronization device 100A when the time synchronization device 100A transmits the Sync message. In addition, t4 is the device internal time of the time synchronization device 100A when the time synchronization device 100A transmits the Delay_Resp message.

$$Δ t 3 = T {2}^{″} - T {1}^{″} - ( ( T {4}^{″} - T {1}^{″} ) - ( T {3}^{″} - T {2}^{″} ) ) / 2 = T {2}^{″} - ( t 1 + Δ t 2 ) - ( ( ( t 4 + Δ t 2 ) - ( t 1 + Δ t 2 ) ) - ( T {3}^{″} - T {2}^{″} ) ) / 2 = T {2}^{″} - t 1 - ( ( t 4 - t 1 ) - ( T {3}^{″} - T {2}^{″} ) ) / 2 - Δ t 2$$

As described above, the time synchronization device 100A according to the present embodiment includes the time adjustment unit 108 as the synchronization unit. The time adjustment unit 108 acquires, from the offset calculation unit 105, the offset that is the difference between the device internal time (first time) of the time synchronization device 100A and the time (second time) of the time source 5. Then, the time adjustment unit 108 synchronizes the device internal time of the communication device 6 with the time of the time source 5 on the basis of the acquired offset and the device internal time of the time synchronization device 100A. Specifically, the time adjustment unit 108 notifies, via the packet transmission/reception unit 107, the communication device 6 of the time obtained by correcting the device internal time of the time synchronization device 100A on the basis of the acquired offset, and synchronizes the device internal time of the communication device 6 with the time of the time source 5.

Since the device internal time of the communication device 6 can be synchronized with the time of the time source 5 without communication between the time source 5 and the communication device 6, a network connecting the time source 5 and the communication device 6 is unnecessary, and thus an increase in cost can be suppressed. In addition, since it is not necessary to synchronize the device internal time of the time synchronization device 100A with a plurality of times, it is possible to prevent the configuration of the time synchronization device 100A from becoming complicated. Therefore, according to the time synchronization device 100A according to the present embodiment, it is possible to synchronize the device internal time of the communication device 6 with the time of the time source 5 different from the device internal time of the own device while suppressing an increase in cost.

### Third Embodiment

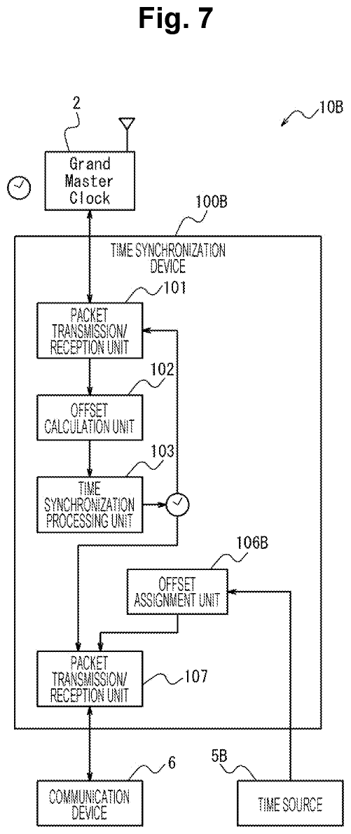

FIG. 7 is a diagram illustrating a configuration example of a time synchronization system 10B to which a time synchronization device 100B according to a third embodiment of the present invention is applied. In FIG. 7, configurations similar to those in FIG. 1 are denoted by the same reference signs, and description thereof will be omitted.

As illustrated in FIG. 7, the time synchronization system 10B includes a Grand Master Clock 2, a time source 5B, a communication device 6, and the time synchronization device 100B. The time synchronization system 10B illustrated in FIG. 7 is different from the time synchronization system 10 illustrated in FIG. 1 in that the time source 5 is changed to the time source 5B and the time synchronization device 100 is changed to the time synchronization device 100B.

Similarly to the time source 5, the time source 5B distributes a time different from that of the Grand Master Clock 2. In addition, the time source 5B measures a difference between a device internal time (first time) of the time source 5B and the UTC (third time), and outputs information indicating the measured difference. That is, the time source 5B is an information providing device that provides the information indicating the difference between the device internal time (first time) of the time source 5B and the UTC (third time).

As illustrated in FIG. 7, the time synchronization device 100B according to the present embodiment includes packet transmission/reception units 101 and 107, an offset calculation unit 102, a time synchronization processing unit 103, and an offset assignment unit 106B. The time synchronization device 100B according to the present embodiment is different from the time synchronization device 100 according to the first embodiment in that the packet transmission/reception unit 104 and the offset calculation unit 105 are deleted and the offset assignment unit 106 is changed to the offset assignment unit 106B.

The offset assignment unit 106B acquires the information indicating the difference between the device internal time of the time source 5B and the UTC from the time source 5B as the information providing device. Similarly to the time synchronization device 100, the time synchronization device 100B synchronizes a device internal time of the time synchronization device 100B with a device internal time (that is, the UTC) of the Grand Master Clock 2. Since the device internal time of the time synchronization device 100B is synchronized with the UTC, the offset assignment unit 106B can acquire (estimate) an offset that is a difference between the device internal time of the time synchronization device 100B and a time of the time source 5B on the basis of the information acquired from the time source 5B. As described above, the offset assignment unit 106B is different from the offset assignment unit 106 in the method of acquiring the offset.

When acquiring the offset, similarly to the offset assignment unit 106, the offset assignment unit 106B notifies the communication device 6 of the device internal time of the time synchronization device 100B and the acquired offset.

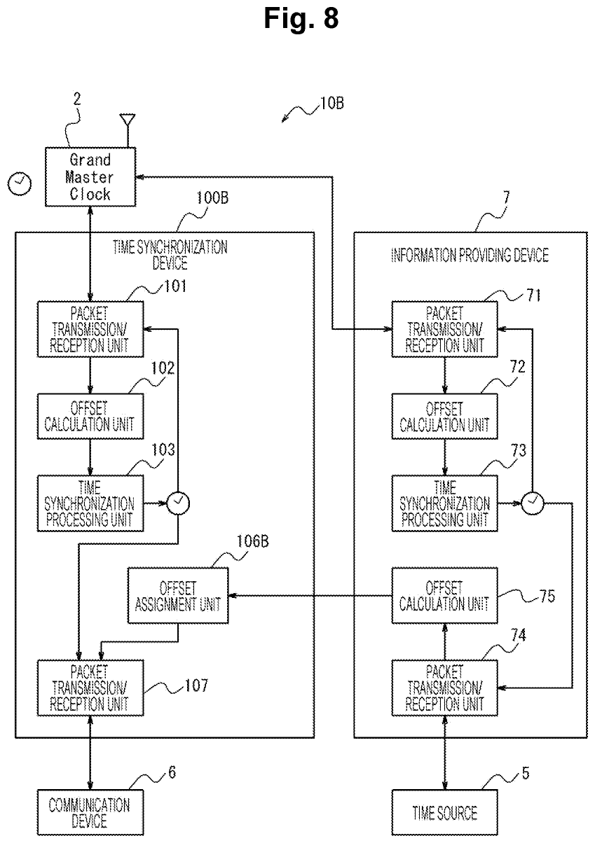

Note that, in FIG. 7, the example in which the time source 5B is the information providing device has been described, but the present disclosure is not limited thereto. For example, an information providing device that measures a difference between the time of the time source 5 and the time distributed by the Grand Master Clock 2 (that is, the UTC) and outputs information indicating the measured difference may be separately provided. In this case, the offset assignment unit 106B acquires the information from the information providing device. FIG. 8 is a diagram illustrating a configuration example of the time synchronization system 10B further including an information providing device 7 as described above. In FIG. 8, configurations similar to those in FIGS. 1 and 7 are denoted by the same reference signs, and description thereof will be omitted.

As illustrated in FIG. 8, the time synchronization system 10B includes the Grand Master Clock 2, a time source 5, the information providing device 7, and the time synchronization device 100B.

The information providing device 7 measures a difference between a time of the time source 5 and a time distributed by the Grand Master Clock 2 (that is, the UTC), and outputs information indicating the measured difference. As illustrated in FIG. 8, the information providing device 7 includes packet transmission/reception units 71 and 74, offset calculation units 72 and 75, and a time synchronization processing unit 73.

The packet transmission/reception unit 71, the offset calculation unit 72, and the time synchronization processing unit 73 have functions similar to those of the packet transmission/reception unit 101, the offset calculation unit 102, and the time synchronization processing unit 103, respectively. Therefore, the packet transmission/reception unit 71, the offset calculation unit 72, and the time synchronization processing unit 73 can synchronize a device internal time of the information providing device 7 with the device internal time of the Grand Master Clock 2.

The packet transmission/reception unit 74 and the offset calculation unit 75 have functions similar to those of the packet transmission/reception unit 104 and the offset calculation unit 105, respectively. Therefore, the packet transmission/reception unit 74 and the offset calculation unit 75 can measure the difference between the device internal time of the time source 5 with the time distributed by the Grand Master Clock 2. The offset calculation unit 75 outputs information indicating the measured difference from the time distributed by the Grand Master Clock 2. The offset assignment unit 106B of the time synchronization device 100B acquires the information output from the offset calculation unit 75.

According to the time synchronization device 100B according to the present embodiment, the packet transmission/reception unit 104 and the offset calculation unit 105 are unnecessary compared with the time synchronization device 100 according to the first embodiment, so that the device configuration can be simplified.

### Fourth Embodiment

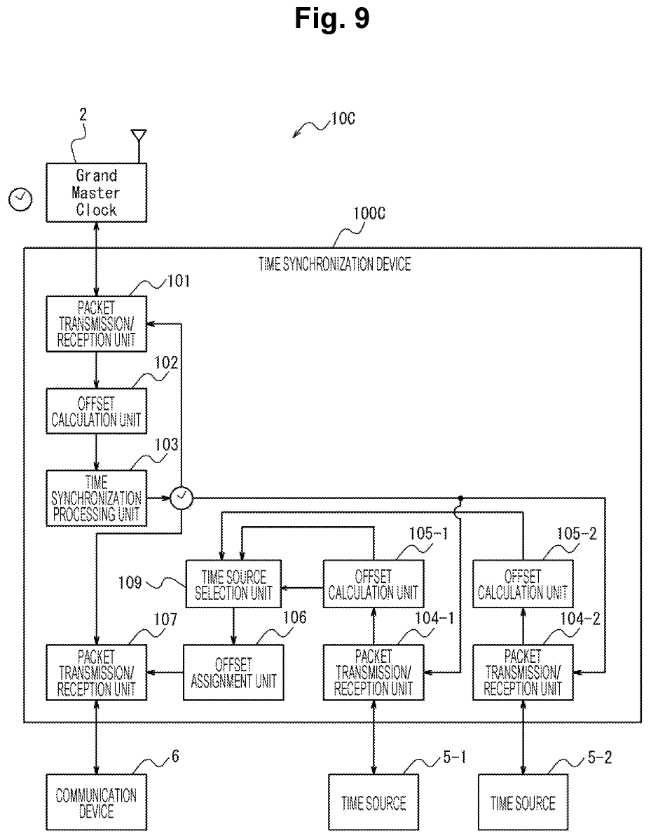

FIG. 9 is a diagram illustrating a configuration example of a time synchronization system 10C to which a time synchronization device 100C according to a fourth embodiment of the present disclosure is applied. In FIG. 9, configurations similar to those in FIG. 1 are denoted by the same reference signs, and description thereof will be omitted.

As illustrated in FIG. 9, the time synchronization system 10C includes a Grand Master Clock 2, a plurality of time sources 5 (time sources 5-1 and 5-2), a communication device 6, and the time synchronization device 100C. The time synchronization system 10C illustrated in FIG. 9 is different from the time synchronization system 10 illustrated in FIG. 1 in that the plurality of time sources 5 is provided and the time synchronization device 100 is changed to the time synchronization device 100C.

Each of the time sources 5-1 and 5-2 outputs a unique time different from the UTC. In addition, the time source 5-1 and the time source 5-2 output different times. Each of the plurality of time sources 5-1 and 5-2 is, for example, a time source managed by a television station, a power company, or the like.

The time synchronization device 100C synchronizes a device internal time of the communication device 6 with a time of any one of the plurality of time sources 5.

As illustrated in FIG. 9, the time synchronization device 100C according to the present embodiment includes packet transmission/reception units 101, 104-1, 104-2, and 107, offset calculation units 102, 105-1, and 105-2, an offset assignment unit 106, and a time source selection unit 109. The time synchronization device 100C according to the present embodiment is different from the time synchronization device 100 according to the first embodiment in that the plurality of packet transmission/reception units 104 (packet transmission/reception units 104-1 and 104-2) is provided, the plurality of offset calculation units 105 (offset calculation units 105-1 and 105-2) is provided, and the time source selection unit 109 is added.

The packet transmission/reception unit 104-1 generates a PTP packet on the basis of a device internal time of the time synchronization device 100C, and performs transmission and reception of the PTP packet with the time source 5-1. The packet transmission/reception unit 104-1 outputs the packet received from the time source 5-1 to the offset calculation unit 105-1.

The packet transmission/reception unit 104-2 generates a PTP packet on the basis of the device internal time of the time synchronization device 100C, and performs transmission and reception of the PTP packet with the time source 5-2. The packet transmission/reception unit 104-2 outputs the packet received from the time source 5-2 to the offset calculation unit 105-2.

The offset calculation unit 105-1 calculates an offset that is a difference between the device internal time of the time source 5-1 and the device internal time of the time synchronization device 100C. Specifically, the offset calculation unit 105-1 acquires a time stamp from the packet output from the packet transmission/reception unit 104-1, and calculates the offset on the basis of the acquired time stamp. The offset calculation unit 105-1 outputs a result of the calculation of the offset to the time source selection unit 109.

The offset calculation unit 105-2 calculates an offset that is a difference between the device internal time of the time source 5-2 and the device internal time of the time synchronization device 100C. Specifically, the offset calculation unit 105-2 acquires a time stamp from the packet output from the packet transmission/reception unit 104-2, and calculates the offset on the basis of the acquired time stamp. The offset calculation unit 105-2 outputs a result of the calculation of the offset to the time source selection unit 109.

The time source selection unit 109 selects one offset from the offsets output from the plurality of offset calculation units 105 (offset calculation units 105-1 and 105-2), and outputs the offset to the offset assignment unit 106. For example, the time source selection unit 109 selects the offset corresponding to the time source 5 selected by the communication device 6 among the offsets acquired for the plurality of time sources 5, and outputs the offset to the offset assignment unit 106. In addition, the time source selection unit 109 may set in advance that the device internal time of the communication device 6 is to be synchronized with the time of which of the plurality of time sources 5. In this case, according to the setting, the time source selection unit 109 outputs the offset acquired for the one time source 5 among the plurality of time sources 5 to the offset assignment unit 106 according to the communication device 6 whose device internal time is to be synchronized.

The offset assignment unit 106 generates offset information indicating the offset (offset acquired for the one time source 5 among the plurality of time sources 5) output from the time source selection unit 109, and outputs the offset information to the packet transmission/reception unit 107. The offset information is notified to the communication device 6 together with the device internal time of the time synchronization device 100C, by transmission and reception of a PTP packet with the communication device 6 by the packet transmission/reception unit 107. Similarly to that of the first embodiment, the communication device 6 synchronizes the device internal time of the communication device 6 with the time of the one time source 5.

As described above, in the present embodiment, the offset assignment unit 106 as the synchronization unit synchronizes the device internal time of the communication device 6 with the time (first time) output by the one time source 5 on the basis of the offset acquired for the one time source 5 among the offsets acquired for the plurality of time sources 5 outputting different times and the device internal time (second time) of the time synchronization device 100C.

Note that, in the present embodiment, the description has been made by using an example in which the time synchronization device 100C has the configuration in which the function of acquiring the offset for each of the plurality of time sources 5 and the function of synchronizing the device internal time of the communication device 6 with the time output by the one time source 5 among the plurality of time sources 5 are added to the time synchronization device 100 according to the first embodiment, but the present disclosure is not limited thereto. The time synchronization device 100A according to the second embodiment or the time synchronization device 100B according to the third embodiment may have these functions.

In addition, in FIG. 9, an example in which the time synchronization device 100C acquires the offsets for the two time sources 5 (time sources 5-1 and 5-2) has been described, but the present disclosure is not limited to these. The time synchronization device 100C may acquire offsets for three or more time sources 5. That is, the time synchronization device 100C may include the packet transmission/reception unit 104 and the offset calculation unit 105 as many as the number of time sources 5 from which offsets are acquired.

### Fifth Embodiment

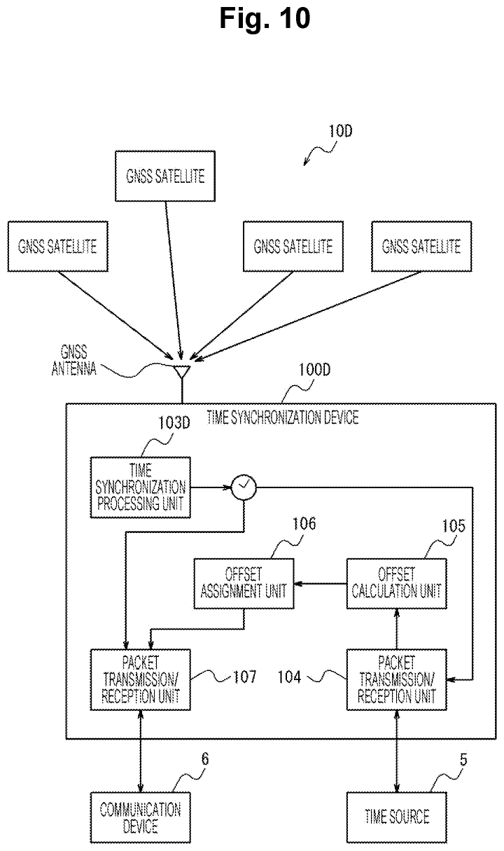

FIG. 10 is a diagram illustrating a configuration example of a time synchronization system 10D to which a time synchronization device 100D according to a fifth embodiment of the present disclosure is applied. In FIG. 10, configurations similar to those in FIG. 1 are denoted by the same reference signs, and description thereof will be omitted.

As illustrated in FIG. 10, the time synchronization system 10D includes a time source 5, a communication device 6, and the time synchronization device 100D. The time synchronization system 10D illustrated in FIG. 10 is different from the time synchronization system 10 illustrated in FIG. 1 in that the Grand Master Clock 2 is deleted and the time synchronization device 100 is changed to the time synchronization device 100D.

As illustrated in FIG. 10, the time synchronization device 100D includes packet transmission/reception units 104 and 107, a time synchronization processing unit 103D, an offset calculation unit 105, and an offset assignment unit 106. In addition, the time synchronization device 100D according to the present embodiment includes a GNSS antenna capable of receiving a GNSS signal from a GNSS satellite. The time synchronization device 100D according to the present embodiment is different from the time synchronization device 100 according to the first embodiment in that the packet transmission/reception unit 101 and the offset calculation unit 102 are deleted and the time synchronization processing unit 103 is changed to the time synchronization processing unit 103D.

The time synchronization processing unit 103D receives GNSS signals transmitted from four or more GNSS satellites by using the GNSS antenna, and acquires the UTC on the basis of the received GNSS signals. The time synchronization processing unit 103D synchronizes a device internal time of the time synchronization device 100D with the acquired UTC.

Note that, in FIG. 10, the description has been made by using an example in which the time synchronization device 100D has the configuration in which the packet transmission/reception unit 101 and the offset calculation unit 102 are deleted from the time synchronization device 100 according to the first embodiment and the function of acquiring the UTC on the basis of the GNSS signals is added, but the present disclosure is not limited thereto. The time synchronization device 100A according to the second embodiment, the time synchronization device 100B according to the third embodiment, or the time synchronization device according to the fourth embodiment may have this function.

Next, a hardware configuration of the time synchronization devices 100, 100A, 100B, 100C, and 100D according to the present embodiment will be described.

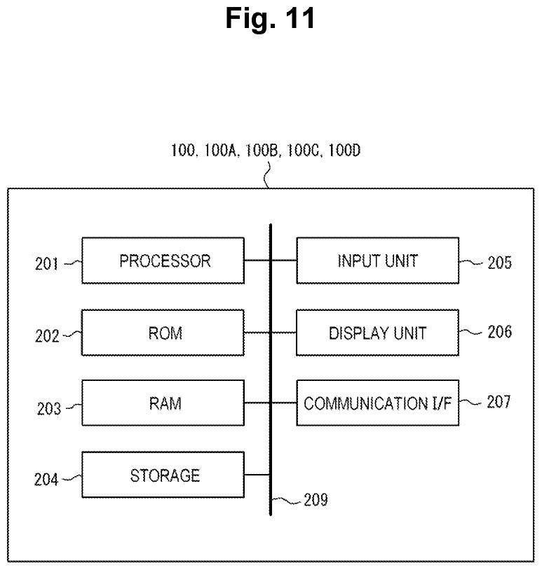

FIG. 11 is a diagram illustrating an example of the hardware configuration of the time synchronization devices 100, 100A, 100B, 100C, and 100D according to the present embodiment. FIG. 11 illustrates an example of the hardware configuration of the time synchronization devices 100, 100A, 100B, 100C, and 100D in a case where the time synchronization devices 100, 100A, 100B, 100C, and 100D include a computer capable of executing a program instruction. Here, the computer may be a general-purpose computer, a dedicated computer, a workstation, a personal computer (PC), an electronic notepad, or the like. The program instruction may be a program code, a code segment, or the like for executing a required task.

As illustrated in FIG. 5, the time synchronization devices 100, 100A, 100B, 100C, and 100D include a processor 201, a read only memory (ROM) 202, a random access memory (RAM) 203, a storage 204, an input unit 205, a display unit 206, and a communication interface (I/F) 207. The components are communicably connected with each other via a bus 209. Specifically, the processor 201 is a central processing unit (CPU), a micro processing unit (MPU), a graphics processing unit (GPU), a digital signal processor (DSP), a system on a chip (SoC), or the like, and may be configured by a plurality of processors of the same type or different types.

The processor 201 is a control unit that executes control of the components and various types of arithmetic processing. That is, the processor 201 reads a program from the ROM 202 or the storage 204 and executes the program by using the RAM 203 as a work area. The processor 201 executes the control of the components and various types of the arithmetic processing described above according to a program stored in the ROM 202 or the storage 204. In the present embodiment, the ROM 202 or the storage 204 stores a program for causing a computer to function as the time synchronization devices 100, 100A, 100B, 100C, and 100D according to the present disclosure. The program is read and executed by the processor 201, whereby each component of the time synchronization devices 100, 100A, 100B, 100C, and 100D is implemented.

The program may be provided in a form in which the program is stored in a non-transitory storage medium such as a compact disk read only memory (CD-ROM), a digital versatile disk read only memory (DVD-ROM), or a universal serial bus (USB) memory. In addition, the program may be downloaded from an external device via a network.

The ROM 202 stores various programs and various types of data. The RAM 203 as a work area temporarily stores programs or data. The storage 204 includes a hard disk drive (HDD) or a solid state drive (SSD) and stores various programs including an operating system and various types of data.

The input unit 205 includes a pointing device such as a mouse and a keyboard, and is used to perform various inputs.

The display unit 206 is, for example, a liquid crystal display, and displays various types of information. The display unit 206 may function as the input unit 205 by employing a touch panel system.

The communication interface 207 is an interface for communicating with another device (for example, the Grand Master Clock 2 and the communication device 6), and is, for example, an interface for LAN.

A computer can be suitably used to function as each unit of the time synchronization devices 100, 100A, 100B, 100C, and 100D described above. Such a computer can be implemented by storing a program in which processing contents for implementing a function of each unit of the time synchronization devices 100, 100A, 100B, 100C, and 100D are written in a storage unit of the computer and causing a processor of the computer to read and execute the program. That is, the program can cause the computer to function as the time synchronization devices 100, 100A, 100B, 100C, and 100D described above. In addition, the program can also be recorded in a non-transitory storage medium. In addition, the program can also be provided via a network.

Regarding the above embodiments, the following supplementary notes are further disclosed.

### Supplementary Note 1

A time synchronization device that is capable of communicating with a first time source and a communication device as a transmission destination of a first time of the first time source, and that has a second time serving as a reference in the device, the time synchronization device including:
a memory; and
a control unit connected to the memory,
in which the control unit acquires an offset that is a difference between the first time and the second time, and synchronizes a device internal time of the communication device with the first time on the basis of the acquired offset and the second time.

### Supplementary Note 2

The time synchronization device according to Supplementary Note 1, in which
the control unit notifies the communication device of the second time and the offset.

### Supplementary Note 3

The time synchronization device according to Supplementary Note 2, in which
the control unit notifies the communication device of a time obtained by correcting the second time on the basis of the offset.

### Supplementary Note 4

The time synchronization device according to any one of Supplementary Notes 1 to 3, in which
the time synchronization device is further capable of communicating with a second time source having a device internal time synchronized with a third time, and
the control unit synchronizes the second time with the third time by communication with the second time source.

### Supplementary Note 5

The time synchronization device according to Supplementary Note 4, in which
the control unit acquires information indicating a difference between the first time and the third time from an information providing device that provides the information, and acquires the offset on the basis of the acquired information.

### Supplementary Note 6

The time synchronization device according to any one of Supplementary Notes 1 to 5, in which,
on the basis of an offset acquired for one time source among offsets acquired for a plurality of time sources outputting different times and the second time, the control unit synchronizes the device internal time of the communication device with a first time output by the one time source.

### Supplementary Note 7

A time synchronization system including:
a time source that outputs a first time;
a communication device as a transmission destination of the first time of the time source; and
a time synchronization device that is capable of communicating with the time source and the communication device, and that has a second time in the device,
in which the time synchronization device acquires an offset that is a difference between the first time and the second time, and synchronizes a device internal time of the communication device with the first time on the basis of the acquired offset and the second time.

### Supplementary Note 8

A time synchronization method by a time synchronization device that is capable of communicating with a first time source and a communication device as a transmission destination of a first time of the first time source, and that has a second time serving as a reference in the device, the time synchronization method including:
acquiring an offset that is a difference between the first time and the second time; and
synchronizing a device internal time of the communication device with the first time on the basis of the acquired offset and the second time.

Although the above embodiments have been described as representative examples, it is obvious to those skilled in the art that many changes and substitutions can be made within the spirit and scope of the present disclosure. Therefore, it should not be understood that the present invention is limited by the embodiments described above, and various modifications or changes can be made without departing from the scope of the claims. For example, a plurality of configuration blocks described in the configuration diagrams of the embodiments can be combined into one, or one configuration block can be divided.

### REFERENCE SIGNS LIST

10, 10A, 10B, 10C, 10D, 10a Time synchronization system
2, 2a Grand Master Clock
3 Boundary Clock
4, 4a Client device
5 Time source
6 Communication device
71, 74, 101, 104, 104-1, 104-2, 107 Packet transmission/reception unit
72, 75, 102, 105, 105-1, 105-2 Offset calculation unit
73, 103, 103D Time synchronization processing unit
100, 100A, 100B, 100C, 100D Time synchronization device
106, 106B Offset assignment unit (Synchronization unit)
108 Time adjustment unit (Synchronization unit)
109 Time synchronization processing unit
201 Processor
202 ROM
203 RAM
204 Storage
205 Input unit
206 Display unit
207 Communication I/F
209 Bus

1. A time synchronization device for communicating with a first time source and a communication device as a transmission destination of a first time of the first time source, the time synchronization device having a second time serving as a reference in the device, the time synchronization device comprising:
a synchronization unit configured to:
acquire an offset that is a difference between the first time and the second time, and
synchronize a device internal time of the communication device with the first time based on the acquired offset and the second time.

2. The time synchronization device according to claim 1, wherein
the synchronization unit is configured to notify the communication device of the second time and the offset.

3. The time synchronization device according to claim 1, wherein
the synchronization unit is configured to notify the communication device of a time obtained by correcting the second time based on the offset.

4. The time synchronization device according to claim 1, wherein
the time synchronization device is configured to communicate with a second time source having a device internal time synchronized with a third time,
the time synchronization device further comprising a time synchronization processing unit configured to synchronize the second time with the third time by communication with the second time source.

5. The time synchronization device according to claim 4, wherein
the synchronization unit is configured to acquire information indicating a difference between the first time and the third time from an information providing device that provides the information, and the synchronization unit is configured to acquire the offset based on the acquired information.

6. The time synchronization device according to claim 1, wherein,
the synchronization unit is configured to synchronize, based on an offset acquired for one time source among offsets acquired for a plurality of time sources outputting different times and the second time, the device internal time of the communication device with a first time output by the one time source.

7. A time synchronization system comprising:
a time source configured to output a first time;
a communication device configured to operate as a transmission destination of the first time of the time source; and
a time synchronization device configured to communicate with the time source and the communication device, the time synchronization device having a second time in the device,
wherein the time synchronization device is configured to acquire an offset that is a difference between the first time and the second time, and the time synchronization device is configured to synchronize a device internal time of the communication device with the first time based on the acquired offset and the second time.

8. A time synchronization method by a time synchronization device for communicating with a first time source and a communication device as a transmission destination of a first time of the first time source, the time synchronization device having a second time serving as a reference in the device, the time synchronization method comprising:
acquiring an offset that is a difference between the first time and the second time; and
synchronizing a device internal time of the communication device with the first time based on the acquired offset and the second time.

9. The time synchronization system according to claim 7, wherein
the time synchronization device is configured to notify the communication device of the second time and the offset.

10. The time synchronization system according to claim 7, wherein
the time synchronization device is configured to notify the communication device of a time obtained by correcting the second time based on the offset.

11. The time synchronization system according to claim 7, wherein
the time synchronization device is configured to communicate with a second time source having a device internal time synchronized with a third time,
the time synchronization device further comprising a time synchronization processing unit configured to synchronize the second time with the third time by communication with the second time source.

12. The time synchronization system according to claim 11, wherein
the time synchronization device is configured to acquire information indicating a difference between the first time and the third time from an information providing device that provides the information, and the time synchronization device is configured to acquire the offset based on the acquired information.

13. The time synchronization system according to claim 11, wherein,
the time synchronization device is configured to synchronize, based on an offset acquired for one time source among offsets acquired for a plurality of time sources outputting different times and the second time, the device internal time of the communication device with a first time output by the one time source.

14. The time synchronization method according to claim 8, further comprising:
notifying, by the time synchronization device, the communication device of the second time and the offset.

15. The time synchronization method according to claim 8, further comprising:
notifying, by the time synchronization device, the communication device of a time obtained by correcting the second time based on the offset.

16. The time synchronization method according to claim 8, further comprising:
communicating, by the time synchronization device, with a second time source having a device internal time synchronized with a third time,
synchronizing, by a time synchronization processing unit of the time synchronization device, the second time with the third time by communication with the second time source.

17. The time synchronization method according to claim 16, further comprising:
acquiring, by the time synchronization device, information indicating a difference between the first time and the third time from an information providing device that provides the information; and
acquiring, by the time synchronization device, the offset based on the acquired information.

18. The time synchronization method according to claim 8, further comprising:
synchronize, by the time synchronization device based on an offset acquired for one time source among offsets acquired for a plurality of time sources outputting different times and the second time, the device internal time of the communication device with a first time output by the one time source.
